(19) United States
(12) Patent Application Publication
(10) Pub. No.: US 2024/0292835 A1
(43) Pub. Date: Sep. 5, 2024

(54) Methods, Compositions and Devices for Insect Control

(71) Applicants: Agriculture Victoria Services PTY LTD, Bundoora, VICTORIA (AU); Horticulture Innovation Australia Limited, Sydney NSW (AU)

(72) Inventors: Kevin Farnier, Mill Park (AU); John Cunningham, Ivanhoe (AU); Farrukh Baig, Multan (PK)

(73) Assignees: Agriculture Victoria Service PTY LTD, Bundoora, VICTORIA (AU); Horticulture Innovation Australia Limited, Sydney NSW (AU)

(21) Appl. No.: 18/266,048

(22) PCT Filed: Mar. 17, 2021
(86) PCT No.: PCT/AU2021/050242

§ 371 Date: Jun. 8, 2023

(30) Foreign Application Priority Data
Dec. 9, 2020 (AU) 2020904576

(51) Int. Cl. A01N 27/00; A01M 1/02; A01P 19/00

(52) U.S. Cl. CPC A01N 27/00; A01M 1/023; A01M 1/026; A01P 19/00

(57) ABSTRACT

The present invention relates to chemical compounds and compositions, an apparatus for dispensing said chemical compounds and compositions, and devices for attracting, trapping and/or monitoring insects, more particularly Carpophilus beetles, such as the almond beetle, Carpophilus truncatus. The present invention also relates to methods for attracting and trapping Carpophilus beetles.

### FIELD OF THE INVENTION

The present invention relates to compositions for attracting pests such as beetles, more particularly Carpophilus beetles including Carpophilus truncatus. The present invention also relates to an apparatus for dispensing the composition, a device for trapping pests such as beetles and a method of attracting and/or trapping pests such as beetles.

### BACKGROUND OF THE INVENTION

Carpophilus truncatus is a major pest of almonds, causing significant damage to developing kernels. “Attract and Kill” strategies to control this pest rely on a lure composed of (i) beetle aggregation pheromone (produced by adult males of stone fruit attacking Carpophilus beetles) combined with (ii) a microbe-derived synthetic food attractant.

However, existing lures developed to control stone fruit attacking Carpophilus beetles are not as effective against C. truncatus.

Pheromones and analogues have previously been synthesized and identified in the 1990s for various Carpophilus species (Bartelt et al. 1990, 1992; Bartelt 2010). However, as an emerging pest still awaiting formal taxonomic description, the pheromones of Carpophilus truncatus have not yet been studied or identified.

There exists a need to overcome, or at least alleviate, one or more of the difficulties or deficiencies associated with the prior art.

### SUMMARY OF THE INVENTION

In one aspect, the present invention provides a composition for attracting Carpophilus beetles, said composition including one or more pheromone compounds produced by male Carpophilus beetles of the species Carpophilus truncatus (this species name being synonymous with Carpophilus jarijari and Carpophilus near dimidiatus). More preferably, the pheromone compounds may be methyl and/or ethyl branched polyenes.

In a preferred embodiment of this aspect of the invention, the pheromone compounds may be selected from (2E,4E,6E,8E)-7-Ethyl-3,5-dimethyl-2,4,6,8-decatetraene and (2E,4E,6E,8E)-3,5,7-trimethyl-2,4,6,8-undecatetraene. More preferably, the composition includes both (2E,4E,6E,8E)-7-Ethyl-3,5-dimethyl-2,4,6,8-decatetraene and (2E,4E,6E,8E)-3,5,7-trimethyl-2,4,6,8-undecatetraene. In a particularly preferred embodiment, the composition substantially excludes pheromones other than (2E,4E,6E,8E)-7-Ethyl-3,5-dimethyl-2,4,6,8-decatetraene and (2E,4E,6E,8E)-3,5,7-trimethyl-2,4,6,8-undecatetraene.

In a preferred embodiment of this aspect of the invention, the (2E,4E,6E,8E)-7-Ethyl-3,5-0 dimethyl-2,4,6,8-decatetraene and (2E,4E,6E,8E)-3,5,7-trimethyl-2,4,6,8-undecatetraene may be present in the composition at a ratio of between approximately 1:1 and 1:100 (v/v); more preferably between approximately 1:5 and 1:50 (v/v); even more preferably between approximately 1:10 and 1:20 (v/v), even more preferably a ratio of approximately 1:15 (v/v).

In a preferred embodiment of this aspect of the invention, the composition may include a co-attractant mixture. The co-attractant mixture may include one or more compounds selected from the group consisting of ethanol, acetaldehyde, ethyl acetate, isobutanol, isopentyl alcohol, and 2-methylbutanol. Preferably, the co-attractant mixture includes at least one alcohol. More preferably, the alcohol may be ethanol and/or isopentyl alcohol.

In a preferred embodiment of this aspect of the invention, the co-attractant mixture may include both ethanol and isopentyl alcohol. Preferably, these are present in the composition at a ratio approximately between 1:10 and 1:100 (v/v); more preferably between approximately 1:40 and 1:60 (v/v); even more preferably a ratio of approximately 1:56 (v/v).

In a preferred embodiment of this aspect of the invention, the attracted Carpophilus beetles may be of the species Carpophilus truncatus (synonymous with Carpophilus jarijari and Carpophilus near dimidiatus), Carpophilus hemipterus, Carpophilus davidsoni, Carpophilus humeralis. More preferably, the attracted Carpophilus beetles may be almond beetles or may be beetles of the species Carpophilus truncatus (synonymous with Carpophilus jarijari and Carpophilus near dimidiatus).

Preferably, the composition may be a liquid and/or gas mixture. In an alternatively preferred embodiment the composition may include a gel.

The composition may further include a diluent, such as water.

In a preferred embodiment of this aspect of the invention, there is provided a composition for attracting Carpophilus beetles, said composition including (2E,4E,6E,8E)-7-Ethyl-3,5-dimethyl-2,4,6,8-decatetraene, (2E,4E,6E,8E)-3,5,7-trimethyl-2,4,6,8-undecatetraene, and one or more co-attractants selected from the group consisting of ethanol, isopropanol, acetaldehyde, ethyl acetate, isobutanol, isopentyl alcohol, and 2-methylbutanol.

In a particularly preferred embodiment of this aspect of the invention, there is provided a composition for attracting Carpophilus beetles, said composition including (2E,4E,6E,8E)-7-Ethyl-3,5-dimethyl-2,4,6,8-decatetraene, (2E,4E,6E,8E)-3,5,7-trimethyl-2,4,6,8-undecatetraene, ethanol and isopropanol.

In a second aspect of the present invention there is provided an apparatus for dispensing a composition as hereinbefore described. In a preferred embodiment of this aspect of the invention, the apparatus may provide for regulated release of the composition. More preferably, the apparatus may provide for regulated release of the composition for between approximately 1 to 8 weeks, more preferably between approximately 1 to 4 weeks.

In a preferred embodiment of this aspect of the invention, the apparatus may include at least one deposit element for storage of the composition, and at least one casing for housing the deposit element, wherein the deposit element releases the composition and the casing provides a means for release of the composition into the surrounding environment.

By a deposit element as used herein is meant any suitable substance which the composition can be stored in and released from. In an embodiment, the deposit element may be a cotton roll/dental wick or any other such substance suitable for storage and release of the composition.

By a casing as used herein is meant any suitable substance capable of storing the deposit element, such that it is capable of allowing for release of the composition stored within the deposit element to the surrounding environment external to the casing. The release of said composition from the casing may be either passive or active.

In a preferred embodiment the apparatus provides for each compound, of the composition as described herein, to be is stored within a separate deposit element.

In a preferred embodiment, the apparatus as described herein includes a casing made of low-density polyethylene. Preferably the casing is made of low-density polyethylene having a thickness of between approximately 25 μm to 250 μm, more preferably between approximately 35 μm to 225 μm. In a particularly preferred embodiment, the casing is made of low-density polyethylene having a thickness of between approximately 50 μm to 200 μm.

In an alternatively preferred embodiment, the apparatus may be a septum, preferably a rubber septum.

In a preferred embodiment, there is provided an apparatus for attracting Carpophilus beetles, said apparatus including:
a composition as hereinbefore described;
at least one deposit element for storage of the composition; and
at least one casing for housing a deposit element,
   wherein the deposit element releases the composition and the casing provides a means for release of the composition into the surrounding environment.

In a preferred embodiment there is provided a device for trapping Carpophilus beetles, said device including a composition as described herein.

In a preferred embodiment there is provided a device for trapping Carpophilus beetles, said device including one or more of the apparatus as described herein.

In a further aspect of the present invention there is provided a method of attracting and/or trapping Carpophilus beetles including the step of exposing a beetle infested environment to a composition, apparatus, and/or device as described herein.

In a preferred embodiment, there is provided a method of monitoring for the presence of Carpophilus beetles including positioning a composition, an apparatus or a device, as described herein, within an environment that requires monitoring for the presence of beetles.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably expected to be combined by a person skilled in the art.

The present invention will now be more fully described with reference to the accompanying Examples and drawings. It should be understood, however, that the description following is illustrative only and should not be taken in any way as a restriction on the generality of the invention described above.

### BRIEF DESCRIPTION OF THE DRAWINGS/FIGURES

In the Figures:

FIG. 1. Photograph of the live C. truncatus insect preparation used in GC-EAD. The beetle is secured inside a pipette tip using cotton wool, with its head and thorax protruding. A fine glass reference electrode (left side) filled with electrolyte is inserted under the cuticle in the neck area. The antenna is moistened and held in place by the recording electrode (right side).

FIG. 2. Schematic representation of the cage experiment setup used to test C. truncatus preference for test and control co-attractant solutions (Example 8, Table 4). The formula used to calculate attraction indices is presented in the yellow frame. Indices vary between −1 (strong avoidance of test solution) and +1 (strong attraction preference for test solution).

FIG. 3. Photograph of a black funnel trap used for the trapping of C. truncatus in an almond orchard. The trap is secured at ground level inside a ring tied to a picket sunk into the soil. The lure, be it composed of a co-attractant solution, or solution, sachets and pheromone compounds loaded on septa, is placed inside the trap in conjunction with an insecticidal strip.

FIG. 4. A sachet dispenser, comprising a heat-sealed low density polyethylene (LDPE) sachet (10) with composition infused wick (20).

FIG. 5. Results of field trial testing the influence of trap position on beetle catches. All traps were baited with the same co-attractant solution (no pheromones). Each treatment was replicated five times. The trial was run over 5 weeks during which the co-attractant solutions were replaced weekly. Grey bars represent C. truncatus mean weekly catches and white bars other non-target Carpophilus catches. Capital letters above bars indicate statistical differences in C. truncatus catches among treatments, and lower case those of the non-target species. Despite a lack of statistical significance between catches obtained from traps placed at 1.5 m height (pickets) and at ground level, there was a visible trend for greater C. truncatus catches when traps were placed on the ground.

FIG. 6. Bar charts representing the responses of C. truncatus males and females in Y-tube olfactometer experiments. Insects were given a choice between two odours. Odour treatments were: artificial diet occupied by a male (♂) or female (♀) conspecifics, diet alone (star), or clean air (blank). Reproduced from Baig 2020 (PhD thesis, August 2020).

FIG. 7. GC-MS chromatograms of the headspace of artificial diet (star), a female (♀) and male (♂) C. truncatus, placed on artificial diet. The arrow indicates a distinctive peak found in the headspace of male beetles only (putative pheromone). Reproduced from Baig 2020 (PhD thesis, July 2020).

FIG. 8. Mass spectrum of the putative pheromone (molecular ion, m/z=190).

FIG. 9. Gas-chromatography coupled with electroantennography (GC-EAD) recordings of female C. truncatus to a) male beetle odour extract and b) an extract of commercial synthetic Carpophilus pheromones. Starred traces correspond to electroantennograms and diamond traces to the FID signal. The asterisks indicate the most consistent physiological responses observed across all beetles tested and annotated peaks show the corresponding GC. Peaks 2, 4, 7, 8, 10 and 11 are known pheromones of the stone fruit beetles, C. hemipterus and C. davisoni while peaks 1, 3, 5, 6 and 9 are contaminants (synthesis and/or chromatographic pheromone by-products). Similar retention times and responses to compounds 8 and 10 (both MW=190) that appear to be present in both, beetle extracts and the tri-species mix suggest that C. truncatus may share pheromones with other Carpophilus species. The tri-species mix is a commercially available synthetic lure (“Catcha© pheromone lure”) for monitoring and managing Carpophilus beetles, Carpophilus davidsoni, Carpophilus hemipterus, and Carpophilus mutilatus.

FIG. 10. (a-b) GC chromatograms of concentrated beetle odour and tri-species pheromone lure solvent extracts, respectively; (c-d) chromatograms of fractions containing the isolated pheromone obtained by preparative GC; the asterisk shows a degradation compound found in both beetles and tri-species mix fractions. The dashed line band indicates the peaks targeted during fractionation (time window of approx. 3 see); (e-f) chromatograms of micro-scale hydrogenation products. Adducts with similar retention indices and mass spectra were observed in tri-species and beetle odour fractions.

FIG. 11. Results of Y-tube olfactometer experiments testing C. truncatus male and female adult beetles' responses to a) 20 μl of isolated fractions of the putative pheromone 2 from hexane extracts of tri-species pheromone septa (“synthetic”) and b) 20 μl isolated fractions of the same putative pheromone from hexane extracts of beetle odour collections (“natural”). Diet odour was applied in both arms and the control arm was treated with 20 μl of hexane. Grey bars show the number of beetles that oriented to the arm of the olfactometer where the pheromone extracts were applied, and white bars indicate the number of beetles that chose the control arm. n corresponds to the replication (only responders were considered). Asterisks next to bars indicate levels of statistical significance (binomial tests, * p<0.05; ** p<0.01 and *** p<0.001).

FIG. 12. Results of Y-tube olfactometer experiments testing C. truncatus attraction to a) an isolated fraction of natural pheromone 1 and b) an isolated fraction of pheromone 2. Grey bars show the number of beetles that oriented to the arm of the olfactometer where the pheromone extracts were applied, and white bars indicate the number of beetles that chose the control arm.

FIG. 13. Field results showing increased C. truncatus capture when commercial pheromone septa (which would include pheromone 1 and pheromone 2 alongside other Carpophilus pheromones) are used in conjunction with the commercial co-attractant solution. Grey and white bars show the mean weekly capture per trap of C. truncatus and other Carpophilus species. Error bars depicts the standard deviation, and lettering above bars indicate statistical differences between treatments. Treatments were replicated 10 times and the trial was conducted over a 4 week period in two field sites located in Mildura area (VIC).

FIG. 14. Results of laboratory dual-choice cage assays testing C. truncatus attraction to the commercial co-attractant. Approximately one hundred beetles were simultaneously exposed to a solution of co-attractant and water (control). The attraction index was calculated as follows: (no. of beetles in test solution−no. of beetles in control)/(total no. of beetles). Hence, positive indices indicate preferences for the test solution whilst negative indices indicate preference for the control (original Carpophilus co-attractant). Line in the boxplots correspond to the median, top and bottom of the boxplots represent the 75^{th} and 25^{th} percentiles respectively while error bars depict the 5^{th} and 95^{th} percentiles. White dots are outliers. n corresponds to the replication of each experiments.

FIG. 15. Results of laboratory dual-choice cage assays: beetles were offered a choice of the commercial co-attractant (control) and a solution of co-attractant from which one ingredient at a time was suppressed (Example 8, Table 4). The attraction index was calculated as follows: (no. of beetles in test solution−no. of beetles in control)/(total no. of beetles). Hence, positive indices indicate preferences for the test solution whilst negative indices indicate preference for the control (original Carpophilus co-attractant). Line in the boxplots correspond to the median, top and bottom of the boxplots represent the 75^{th} and 25^{th} percentiles respectively while error bars depict the 5^{th} and 95^{th} percentiles. White dots are outliers. n corresponds to the replication of each experiments. p values result from paired t-tests and asterisks indicate the level of statistical significance.

FIG. 16. Results of laboratory dual-choice cage assays assessing C. truncatus preference between the simplified co-attractant (2-component, comprising isopentyl alcohol and ethanol) of varying concentrations of isopentyl alcohol (test solutions) and the simplified co-attractant of the same isopentyl alcohol concentration as that used in the commercial solution (control).

FIG. 17. Results of field trial #1 testing the efficacy of the simplified co-attractant (containing ethanol and isopentyl alcohol) developed using cage bioassays and formulated either in solution or using polyethylene sachets against the commercial co-attractant solution (CL). Bars represent the mean weekly number of beetles caught per trap, obtained over an 8-week period. Error bars represent the standard error. Capital letters above grey bars show statistical differences between treatments for C. truncatus and lower case letters above white bars those of other non-target Carpophilus species. Each treatment was replicated 12 times.

FIG. 18. Results of field trial #2 testing the influence of the concentration of ethanol in the simplified co-attractant on C. truncatus attraction. Bars represent the mean weekly beetle catches per trap obtained over a 5-week period. Error bars represent the standard error. Capital letters above dark bars show statistical differences between treatments for C. truncatus and the lower case letters above white bars those of other non-target Carpophilus species. Each treatment was replicated 10 times. Lures were replaced weekly.

FIG. 19. Results of field trial #3a testing the influence of the concentration of isopentyl alcohol in the reduced version of the stone fruit beetle co-attractant on C. truncatus attraction. Bars represent the mean weekly catch per trap obtained over a 5-week period. Error bars represent the standard error. Capital letters above grey bars show statistical differences between treatments for C. truncatus and the lower case letters above white bars those of other non-target Carpophilus species. Each treatment was replicated 12 times. Lures were replaced weekly.

FIG. 20. Results of field trial #3b testing more concentrations of isopentyl alcohol in the reduced version of the stone fruit beetle co-attractant. Bars represent the mean weekly catch per trap obtained over a 5-week period. Error bars represent the standard error. Capital letters above grey bars show statistical differences between treatments for C. truncatus and the lower case letters above white bars those of other non-target Carpophilus species. Each treatment was replicated 12 times. Lures were replaced weekly.

FIG. 21. Results of field trials comparing the efficacy of the simplified co-attractant (“Ref”) and current commercial co-attractant (“CL”) applied in conjunction with commercial pheromone septa (comprising pheromone compounds identified in Carpophilus truncatus extracts and pheromones compounds of other Carpophilus species). Grey bars represent mean weekly C. truncatus captures per traps and white bars that of other Carpophilus species (mostly C. hemipterus). Error bars represent standard errors. Lettering above bars indicate statistical differences. Each treatment was replicated 12 times. The trial was conducted over a 4-week period in an almond orchard located near Piangil (VIC).

### DETAILED DESCRIPTION OF THE EMBODIMENTS

### Beetles

C. truncatus beetles were obtained from a colony started from wild caught individuals morphologically identified and maintained at AgriBio (Melbourne, Australia). Adults and larvae were kept in plastic containers and fed on a soybean meal/sucrose/almond meal diet (2.5:2.5:1) ratio (w/w/w) at 23° C. Larvae were transferred in an emergence plastic box filled with fine moist vermiculite shortly prior pupation and newly emerged adults transferred in a new plastic box with fresh diet. Beetles used in all experiments were sexed and kept in separate containers shortly after emergence. One- to two-week old virgin male and female beetles were then starved (no access to food or water) for 24-48 hours at 28° C. before testing in the Y-tube.

### Y-Tube Olfactometer Bioassays

Beetle orientation to different test odours was tested in a Y-tube glass olfactometer (ID: 2 cm, 10 cm stem and 7.5 cm choice arm length, 70° angle between arms) placed on a thick white paper sheet. All the experiments were conducted in a Controlled Environment Room at 28° C. The olfactometer was placed at a 30° angle to take advantage of beetles' natural negative geotaxis. Both arms of the Y-tube were connected via glass connectors or PTFE tubing to air-tight glass chambers in which different odours were applied. Activated charcoal-filtered air was circulated through the glass chambers entraining test odours to the choice arms of the Y-tube at 400 mL/min. The olfactometer was illuminated from above by dimmable fluorescent light tubes (Fititron, Weiss Gallenkamp, UK) covered by a sheet of UV-permitting diffusing white screen paper (Rosco 216, Germany). Light intensity at both ends of the two choice arms was measured and adjusted to 990 lux using a digital lux meter. Beetles were released individually in the olfactometer's main stem and observed for 10 min. Individuals that crossed the middle of either test arms (4 cm inside the arm; empirically designated as a non-return point) were considered to have made a choice. Non-responders were excluded from the datasets. The position of the odour sources was switched every five beetles to prevent any positional bias. Y-tube and glass connectors were replaced every ten insects. Used glassware was cleaned in soapy water, rinsed and oven baked for 8 h at 250° C. before re-use. Male and female adult beetle attraction to conspecific odours was achieved by testing their orientation to test arms of the Y-tube connected to 300 ml glass chambers containing either diet infested with beetles of a given sex or diet alone (control). Preferences for male or female odours were assessed in a similar way by testing the beetle's orientation when simultaneous exposed to male and female beetle-infested diet. The concentration of natural and synthetic pheromone extracts obtained as described in the preparative GC section was checked by GC-MS and adjusted as required to approx. 250 pg/μl (via solvent evaporation or addition) before use in the Y-tube olfactometer. The two arms of the olfactometer were connected to small glass vessels filled with approx. 1 g of artificial diet (composition described in the document) secured between two plugs of cotton wool to prevent beetle entry. An aliquot of 20 μl of the pheromone extracts (5 ng of pheromone=one beetle day equivalent) was applied on a small piece of filter paper (Whatman n^{o} 1, 2×1 cm) and placed at the far end of one arm of the Y-tube while 20 μl of hexane was loaded on a similar piece of filter paper placed in the control arm. The olfactometer was left to equilibrate for 5 minutes to allow the solvent to evaporate prior commencing the experiments. The Y-tube and filter papers were replaced, and the extracts reloaded every five insects to ensure the treatments consistency over time. The position of treatments was also swapped every five insects to prevent any possible positional bias. An equal number of male and female beetles was used every day to prevent any possible day effect.

### Pheromone Sampling and Chemical Analysis

Three-day-old male beetles were placed individually in small glass chambers made of ground glass joints (cone and socket) filled with 2 g of artificial diet and wrapped in aluminium foil. The two extremities of the glass chambers ended with GL14 threads fitted with silicon O-rings and red screw caps with holes. The pointed end of a glass Pasteur pipette filled with activated charcoal packed between two plugs of silanized glass wool was inserted in an air-tight manner at one extremity of the chamber through the hole of the screw cap. Another pipette packed with an adsorbent (200 mg, Porapak Q, 80 mesh) loaded in a similar way was placed on the other extremity of the chamber. A 100 ml.min⁻¹ suction flow applied on the pipette containing the adsorbent was used to force the entry of ambient air into the glass vessel through the charcoal filter (purified air) and entrain the odours confined in the glass chamber (diet and pheromone compounds) onto the adsorbent filter. A network of ramified manifolds made from transparent irrigation tubing and equipped with valves for flow adjustments was used to collect from 24 beetles simultaneously. Collections were made around the clock for several weeks. Adsorbent filters were recollected and replaced with fresh ones on a weekly basis. Trapped volatile compounds were recovered by washing the adsorbent filters with 2 ml of hexane. Collections from multiple beetles over time were pooled and excess solvent evaporated under a gentle stream of purified nitrogen to obtain concentrated extracts used for chemical analysis and/or preparative GC.

Chemical analysis (GC-MS), GC-EAD and preparative GC were all carried out using a gas chromatograph (Agilent 7890B) coupled with an Agilent 5977B single quadrupole mass spectrometer and a flame ionization detector (FID) via a CFT splitter plate. Different GC columns and sets of inert capillary restrictors of varying length and inner diameters were used at the splitter plate depending on the desired effluent ratios between different detectors, while ensuring the synchronization of their respective signals. Standard GC-MS analysis involved the manual injection of 2-3 μl of liquid odour extracts (beetle odour or pheromone septa extracts) in splitless mode at 250° C. Helium was used as carrier and make-up gas in constant flow mode (velocity: 30 cm.s⁻¹). The oven temperature program was initiated at 30° C. maintained for 2 min, then increased at 10° C./min to 250° C. held for 3 min. Ionization was performed in EI mode (70 eV) and scan range was set between m/z 35 and 550. Tentative pheromone compounds identification was done via comparisons of mass spectra and/or retention times with synthetic standards (when available) and using Kovats indices calculated using a nC8-C20 standard solution analysed under identical chromatographic conditions.

### Electrophysiology—GC-EAD

Pheromone compounds and other biologically active compounds present in odour extracts were screened by Gas Chromatography coupled with electroantennography (GC-EAD). The same GC setup used for chemical analysis was used in conjunction with an electroantennograph (Ockenfels Syntech GmbH, Germany). An apolar column SLB-5 MS (30 m×0.32 mm×0.25 μm) used as analytical column was connected to a CFT splitter plate (Capillary Flow Technology, Agilent). A constant flow of helium (1 mL/min) used as carrier and make-up gas was maintained towards the mass spectrometer. An initial 1:1:5 split ratio between the MS, FID and EAD, was achieved using a 2.4 m long inert capillary restrictor (id=0.15 mm) between the splitter plate and the MS in conjunction with 0.83 cm (id=0.25 mm) and 0.54 cm long (id=0.15 mm) restrictors between the splitter plate the EAD and FID, respectively. The EAD restrictor was fitted in a 50 cm transfer line (Ockenfels Syntech GmbH, Germany) heated at 250° C. allowing only the last 2 mm segment of the restrictor to protrude inside a glass mixing tube (3.8 mm inner diameter) positioned above the insect preparation and in which a 29 cm/s stream of purified air was applied. The described setup allowed relatively well-synced signals between all three detectors.

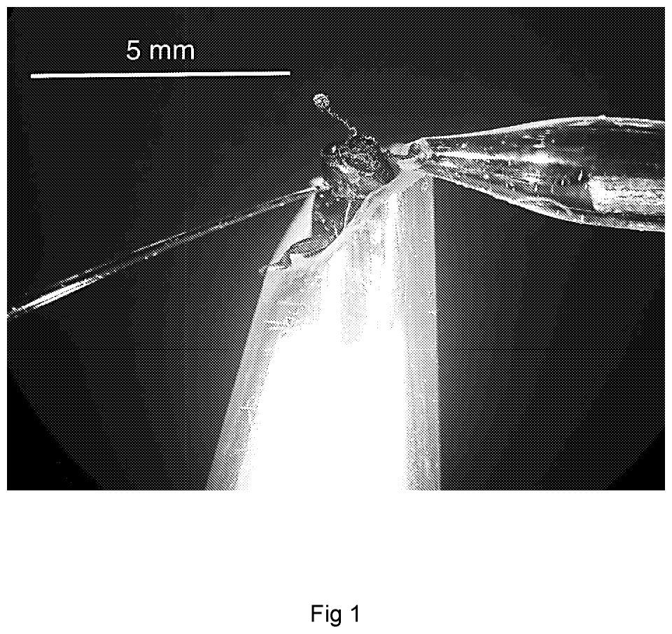

One-week-old beetles were anesthetized on ice and immobilised in a micropipette tip with a cotton plug, with the upper part of the abdomen exposed. A sharp glass electrode filled with an electrolyte (0.1 N KCl, 3% PVP) was inserted into the head of the beetle (reference) while a similar electrode was positioned on the disc-shaped distal end of the antenna using a micromanipulator (FIG. 1). The antennal signal was amplified and recorded using an IDAC-4 (Ockenfels Syntech, Germany). When a good contact was obtained (checked via a 1% isopentyl acetate “puff” stimulation), an aliquot of volatile extract was injected in the GC and the sensitivity or lack thereof to individual compounds was determined by the overlay of MS/FID and EAD signals.

### Preparative GC—Fractionation

Preparative gas chromatography was used to isolate and produce enriched extracts of the putative pheromones used in derivatization reactions (for identification purposes) and Y-tube olfactometer experiments. Concentrated hexane extracts of pheromones collected from either beetles (“natural”) or by solvent extraction of commercial pheromone septa (“synthetic”) were purified by flash chromatography on a silica column to remove polar compounds (present in high concentrations in the odour of beetle diet). Next, 4 μl aliquots of purified extracts were repeatedly injected in the GC-MS in which a wide bore non-polar column (DB-5 MS, 30 m×0.53 mm×0.25 μm) was installed. Only the MS and EAD restrictors were connected to the splitter plate with a set of restrictors allowing a 1:20 ratio between the two lines with the greatest part of the GC effluent directed toward the EAD. During each run, pheromones separated from background odours during chromatography were recollected at the end of the EAD line using an adsorbent filter similar to that used in pheromone collection, connected to a laboratory vacuum pump. The pump was operated at 500 ml.min⁻¹ only for a short time window that corresponded to the elution times of target peaks/compounds. Pheromone 1 and pheromone 2 were collected during the same GC run but trapped on different adsorbent filters. Pheromone extracts were eluted from adsorbent filters with 300 μl of hexane. Obtained extracts were either used in derivatization or in Y-tube olfactometer experiments. The concentration of pheromone extracts used in olfactometer experiments was checked by GC-MS and adjusted to 1 beetle day equivalent per 20 μl (˜250 pg.μl⁻¹) by dilution and/or solvent evaporation.

### Cage Bioassays

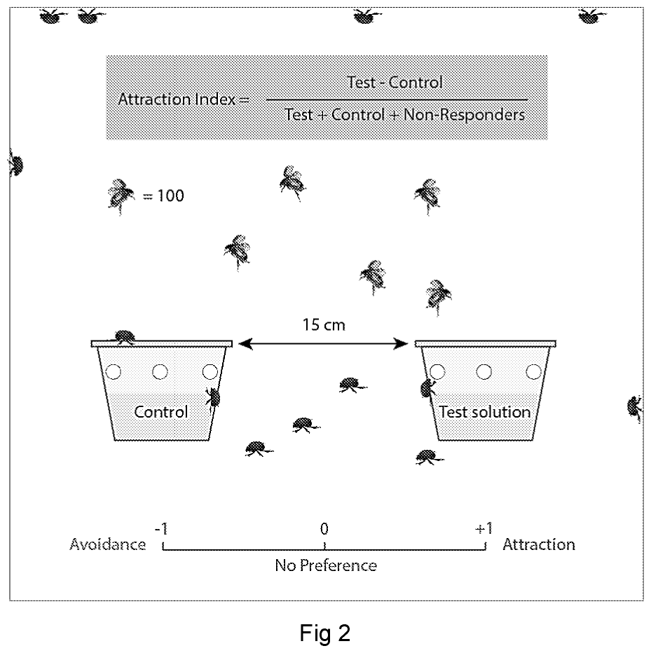

Cage bioassays were developed for the rapid screening of beetle attraction to prototype co-attractant solutions. Adult beetles were separated in groups of hundred individuals (mixed sex) and starved for 48 h in (30 cm×30 cm×30 cm) mesh cages in Controlled Environment rooms (29° C., 60% RH, 16L:8D Photoperiod). Two plastic traps made from 30 mL plastic cups comprising four 5-mm holes equidistantly distributed along their circumference and a single hole in the lid were filled with 20 mL of freshly prepared test co-attractant solutions (FIG. 2) and placed inside the mesh cage approximately 15-20 cm apart. Beetles were allowed 48 h to choose between the two solutions. At the end of the experiments, traps were collected in plastic containers and beetles inside each treatment cups (alive or drowned) as well as non-selecting individuals were counted. Experiments were replicated a minimum of ten times for each prototype solution. An attraction index, used to determine the degree of attraction or deterrence of the test solution in comparison to the control, was calculated as follows: (n beetles in test solution)−(n beetles in control)/total n beetles. Attraction indices returned values ranging between −1 (extreme repellence) and +1 (extreme attraction); 0 corresponding to the absence of preference for either solutions. Deviation of the indices from zero was analysed using two tailed t-tests. Cage bioassays were used to test the attraction of C. truncatus to the commercial co-attractant (co-attractant vs water) and to screen the influence of individual constituents of the commercial Carpophilus co-attractant on C. truncatus attraction. The effect of different constituents was assessed by testing the co-attractant (control) against test co-attractant solutions in which one constituent was excluded.

### Field Trials

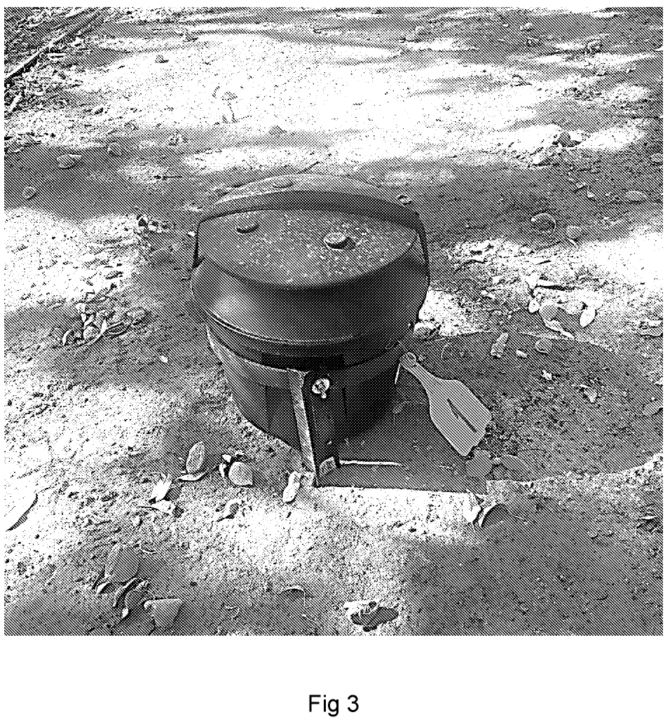

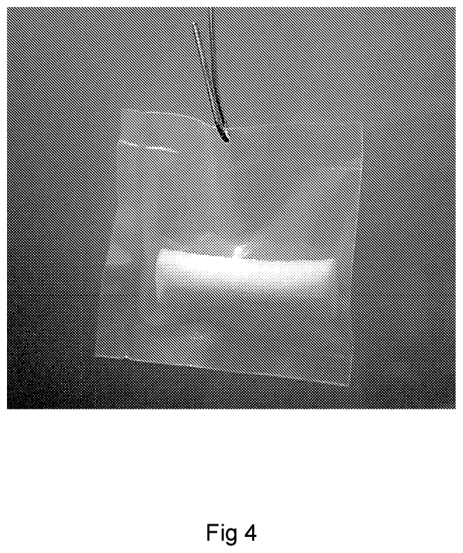

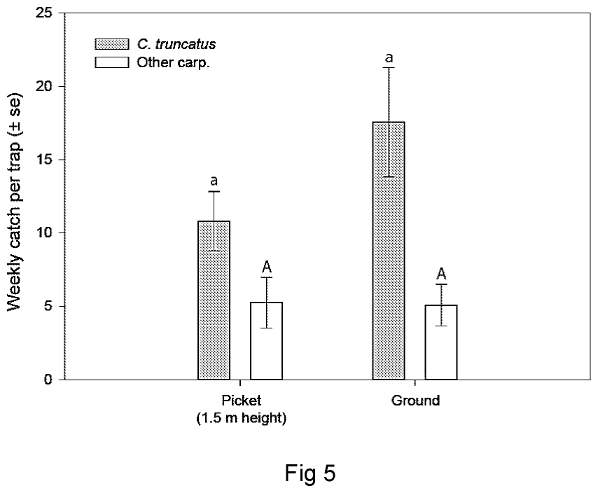

All field trials were conducted in commercial almond orchards located in Mildura area (Victoria, Australia) between 2018 and 2020. Treatments were tested in black funnel traps (supplied by Bugs for Bugs; https://bugsforbugs.com.au/product/Carpophilus-catcha-trap-kit/) placed at ground level and secured using metal fence pickets deeply anchored in the soil (FIG. 3). This differs from the conventional use of these traps in stone fruits where traps are suspended on pickets at 1.5 m height and derives from pilot experiments showing that more C. truncatus are caught when traps are placed on the ground (FIG. 5). An insecticidal strip (dichlorovos) was placed inside the traps to kill captured beetles. A fixed volume of 250 ml of the co-attractant test solutions was placed in open plastic containers (11.0 cm diameter) covered with a piece of mosquito mesh to prevent beetles from drowning in the solution. Rubber septa and/or sachets (FIG. 4) were secured inside the traps by means of paperclips. When three or more lures were tested, treatments were arranged in randomized complete blocks with a minimum of 30 m (in trials that did not involve the use of pheromones) or 50 m distance between traps (in trials that involved the use of pheromones). When only two treatments were compared, those were arranged alternately along and across tree rows, 50 m apart. Co-attractant solution and/or sachets, rubber septa, insecticide strips were replaced weekly at the same time as captured beetles were collected. Used co-attractant solutions were recollected in a waste container and disposed of appropriately. Beetle samples were placed in ziplock bags, tagged with collection date, site, and trap number and sent back to AgriBio in an esky filled with ice where beetles where morphological species identification was carried out.

### Statistical Analysis

Beetles responses to different odours in Y-tube olfactometer experiments were analysed using binomial tests, assuming a distribution ratio of 1:1 between the two choice arms as the null-hypothesis. Similar tests using the number of beetles choosing either side of the Y-tube were carried out to confirm the absence of any positional bias. The deviation from zero of the attraction indices calculated in cage bioassays was analysed using paired t-tests. Field trial data were analysed as the mean weekly catches per trap over the period of the trials (between 2-6 weeks depending on beetle population density) using generalized linear mixed model fitted with a negative binomial distribution. “Lure treatment” was set as a fixed factor whilst “transect” and “field site” (sometimes nested, depending on trials) and “week” were used as random factors wherever they contributed to improve the model. Tukey's post hoc tests with corrections were applied for multiple pairwise comparisons among treatments.

Pheromones and analogues have previously been synthesized and identified in the 1990s for other Carpophilus species (Bartelt et al. 1990, 1992; Bartelt 2010). As an emerging pest still awaiting formal taxonomic description (though now considered to be Carpophilus truncatus based on morphological comparison with international museum type specimens), the pheromones of C. truncatus have not yet been studied or identified. The following examples provide support for the identification and release of pheromones from C. truncatus.

### Example 1—Behavioural Trials Confirming the Release of a Pheromone

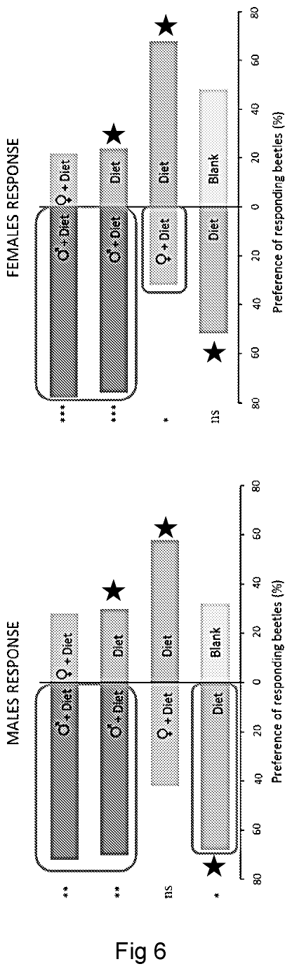

The attraction of adult C. truncatus to conspecifics odours was tested in a Y-tube olfactometer. The results of the Y-tube olfactometer experiments (FIG. 6), have demonstrated that aggregation pheromones are produced by males. It can also be seen that only the odours released by individual males placed on diet, attracted male and female adult conspecifics, as females were observed to emit odours that repelled conspecifics of both sexes.

### Example 2—GC-MS Analysis of Beetle Odour Extracts

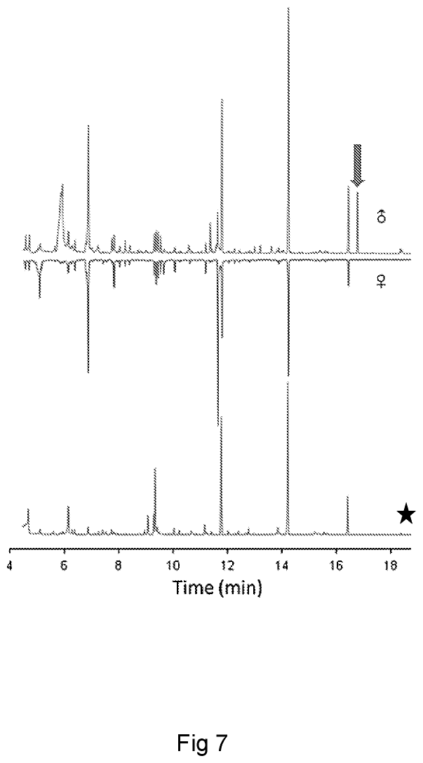

Headspace odours were collected from adult male and female beetles, which were fed on a soybean-almond meal diet. Headspace odours were analysed using GC-MS. A putative pheromone present only in the headspace odour of male beetles on diet was discovered (FIG. 7).

### Example 3—Identification of the Pheromone

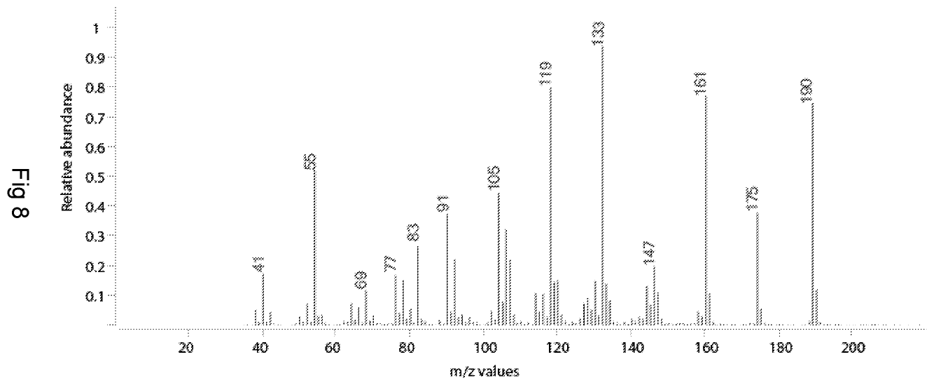

Based on a mass spectrum analysis of the compound (molecular ion: 190), similarities were found to be shared with spectra of previously described Carpophilus species (FIG. 8).

Pheromone production was estimated to be around 5-7 ng/day/beetle (for comparison: >5 μg/day/beetle in C. davidsoni).

### Example 4—Electrophysiology

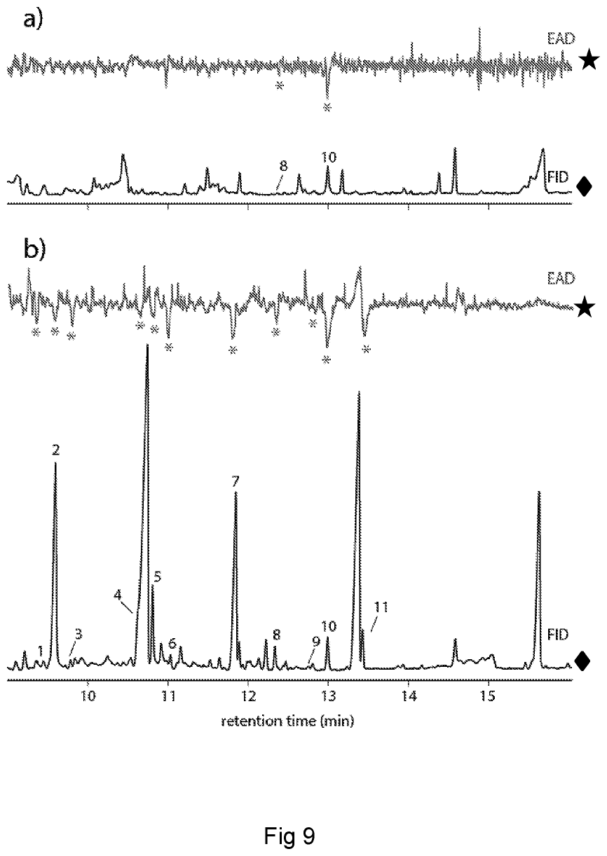

Beetle odour extracts as well as extracts from commercial synthetic Carpophilus pheromones were screened by coupled gas chromatography-electroantennographic detection (GC-EAD) to test for beetle sensitivity to the putative pheromone and those of other Carpophilus species (FIG. 9).

The results revealed that C. truncatus males and females exhibit strong and consistent GC-EAD responses to the putative pheromone.

C. truncatus antennae responded to all but one commercial synthetic pheromone (Table 1).

GC-EAD screening of concentrated beetle odour extracts enabled the detection of another pheromone compound (MW=190) produced in small amounts by adult males.

The two putative pheromones are methyl- and/or ethyl branched polyenes with some degree of instability as a result of re-arrangements during the chromatography (Bartelt et al. 1992). The pheromones present very similar mass spectra and retention indices.

Identification of compounds of most of the pheromone compounds found in commercial tri-species pheromone lure extracts were confirmed by comparison of their retention indices to those of the literature and of standards (when available).

TABLE 1
Retention indices and indentity confirmation of compounds
found in solvent extracts of commercial pheromones septa.

| | | | KI | KI | KI | | |
|---|---|---|---|---|---|---|---|
| | Compound | Species | extr^{a} | synth^{a} | lit^{b} | EAD | ID |
| | (2E,4E,6E)-5-ethyl- | C. davidsoni | 1229 | Not | 1224 | ✓ | X |
| | 3-methyl-2,4,6- | C. hemipterus | | available | | | |
| | nonatriene | C. freemani | | | | | |
| | (MW = 164) | | | | | | |
| | (3E,5E,7E)-6-ethyl- | C. davidsoni | 1303 | Not | 1300 | ✓ | X |
| | 4-methyl-3,5,7- | C. mutilatus | | available | | | |
| | decatriene | C. freemani | | | | | |
| | (MW = 178) | | | | | | |
| | (3E,5E,7E)-5-ethyl- | C. mutilatus | 1396 | 1396 | 1393 | X | ✓ |
| | 7-methyl-3,5,7- | | | | | | |
| | undecatriene | | | | | | |
| | (MW = 192) | | | | | | |
| | (2E,4E,6E,8E)-3,5,7- | C. hemipterus | 1391 | 1390 | 1387 | ✓ | ✓ |
| | Trimethyl-2,4,6,8- | | | | | | |
| | decatetraene | | | | | | |
| | (MW = 176) | | | | | | |
| [symbol] | (2E,4E,6E,8E)-7- | C. hemipterus | 1431 | 1430 | 1428 | ✓ | ✓ |
| | Ethyl-3,5-dimethyl- | | | | | | |
| | 2,4,6,8-decatetraene | | | | | | |
| | (MW = 190) | | | | | | |
| [symbol] | (2E,4E,6E,8E)- | C. davidsoni | 1482 | Not | 1476 | ✓ | X |
| | 3,5,7-trimethyl- | C. hemipterus | | available | | | |
| | 2,4,6,8-undecatetraene | | | | | | |
| | (MW = 190) | | | | | | |
| | (2E,4E,6E,8E)-7-ethyl- | C. davidsoni | 1517 | 1515 | 1515 | ✓ | ✓ |
| | 3,5-dimethyl-2,4,6,8- | C. mutilatus | | | | | |
| | undecatetraene | C. freemani | | | | | |
| | (MW = 204) | | | | | | |

^{a}Kovats indices calculated on a SLB-5MS non-polar column
^{b}Kovats indices calculated on a DB-1 non-polar column as reported in Bartelt et. al. 1992
Starred lines correspond to the two compounds that exhibit strong spectral and chromatographic resemblance with the two putative C. truncatus pheromones

Retention indices and careful comparisons of the mass spectra with a synthetic standard provided sufficient evidence to confirm the identification of one of the two pheromones: namely (2E,4E,6E,8E)-7-Ethyl-3,5-dimethyl-2,4,6,8-decatetraene [Pheromone 1].

Close comparison of the mass spectra and retention indices (on polar and non-polar columns) of the second pheromone [Pheromone 2] with that of the corresponding peak in the tri-species mix suggested that these are the same compound ((2E,4E,6E,8E)-3,5,7-trimethyl-2,4,6,8-undecatetraene).

In the absence of a synthetic standard of (2E,4E,6E,8E)-3,5,7-trimethyl-2,4,6,8-undecatetraene, further work was undertaken to ascertain the identity of Pheromone 2.

### Example 5—Fractionation and Derivatization

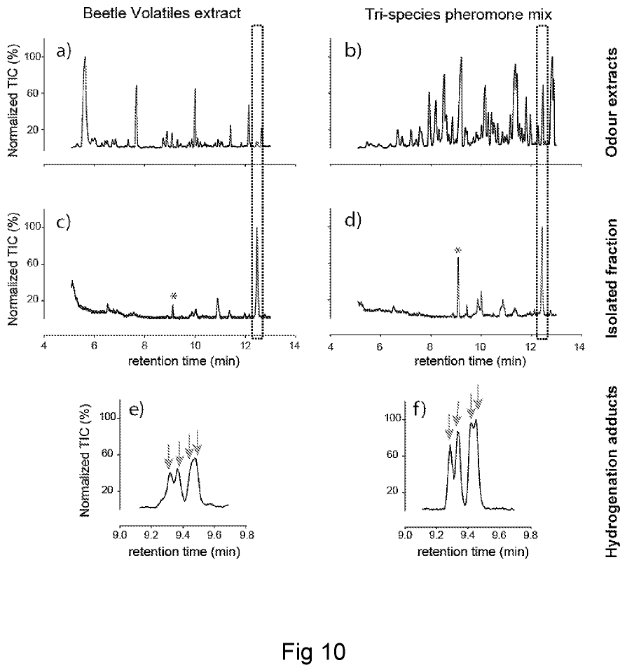

Extensive beetle odour collection was carried out to obtain highly concentrated pheromone extracts. Extracts were then purified on a silica column (to eliminate polar compounds) and used in preparative GC to isolate Pheromone 2 from the diet odour background. In order to confound Pheromone 2 with the pheromone found on the tri-species mix, the latter was also isolated using the same method using concentrated lure extracts. Isolated fractions were subsequently used in behavioural assays (in Y-tube olfactometer) and microscale hydrogenation on Pd/C to compare their attractiveness to C. truncatus and hydrogenation adducts (FIG. 10). To confirm the identity of Pheromone 2, the characteristics of its hydrogenation adducts (number of peaks, retention indices and mass spectra) were also compared with those of (2E,4E,6E,8E)-3,5,7-trimethyl-2,4,6,8-undecatetraene and its closest analogue (2E,4E,6E,8E)-4,6,8-trimethyl-2,4,6,8-undecatetraene described in Bartelt et al. 1992 (Table 2).

The two isolated fractions produced hydrogenation products (four poorly resolved peaks) with similar retention times and mass spectra. All hydrogenation products comprised a molecular ion m/z=198 suggesting the absence of ring and a tetraene structure.

TABLE 2
Comparison of chromatographic and mass spectral data of
the putative pheromones found in beetles' odour and
tri-species pheromone mix and their hydrogenation derivatives
with previously described pheromones and analogues.

| | | | |
|---|---|---|---|
| | | (2E,4E,6E,8E)- | (2E,4E,6E,8E)- |
| Phero 2 | Phero 2 | 3,5,7-trimethyl- | 4,6,8-trimethyl- |
| Beetle | Tri-species | 2,4,6,8- | 2,4,6,8- |
| extract^{a} | mix^{a} | undecatetraene^{b} | undecatetraene^{b} |

Retention indices before hydrogenation

| | | | |
|---|---|---|---|
| 1484 | 1482 | 1476 | 1463 |

Retention indices of hydrogenation products

| | | | | |
|---|---|---|---|---|
| Peak1 | 1243 | 1241 | 1252 | 1242 |
| Peak2 | 1247 | 1245 | 1255 | 1250 |
| Peak3 | 1254 | 1252 | 1261 | 1257 |
| Peak4 | 1255 | 1254 | 1263 | — |

Mass spectral data after hydrogenation

| | |
|---|---|
| m/z | Intensities (% of base peak) |

| | | | | |
|---|---|---|---|---|
| 43 | 41 | 42 | 53 | 75 |
| 57 | 100 | 100 | 100 | 99 |
| 71 | 63 | 73 | 54 | 100 |
| 85 | 54 | 58 | 41 | 30 |
| 99 | 20 | 20 | 16 | 6 |
| 113 | 6 | 8 | 5 | 15 |
| 127 | 13 | 14 | 9 | 4 |
| 141 | 10 | 13 | 7 | 1 |
| 155 | 1 | 0 | 0 | 8 |
| 169 | 4 | 5 | 3 | 0 |
| 183 | 1 | 0 | 1 | 1 |
| 198 | 2 | 3 | 1 | 1 |

^{a}Experimental data, retention indices calculated on a non-polar SLB-5MS column
^{a}Retention indices calculated on a non-polar DB-1 column and mass spectral data as reported in Bartelt et al. 1992

Hydrogenations products and their mass spectra provided sufficient evidence to confound the identity of pheromone 2 in both beetle odour and the tri-species mix extracts.

Likewise, the comparison of the number of peaks of the hydrogenation adducts and of their mass spectra with that of previously described pheromones and analogues allowed to confirm pheromone 2 identity as being (2E,4E,6E,8E)-3,5,7-trimethyl-2,4,6,8-undecatetraene.

### Example 6—Confirmation of the Attraction to the Pheromone Compounds in Y-Tube Olfactometer and Field Trials

Fractions obtained from tri-species mix and beetle odour extracts containing either pheromone 1 ((2E,4E,6E,8E)-7-Ethyl-3,5-dimethyl-2,4,6,8-decatetraene) or pheromone 2 were used to test their respective influence on beetle attraction in Y-tube olfactometer experiments.

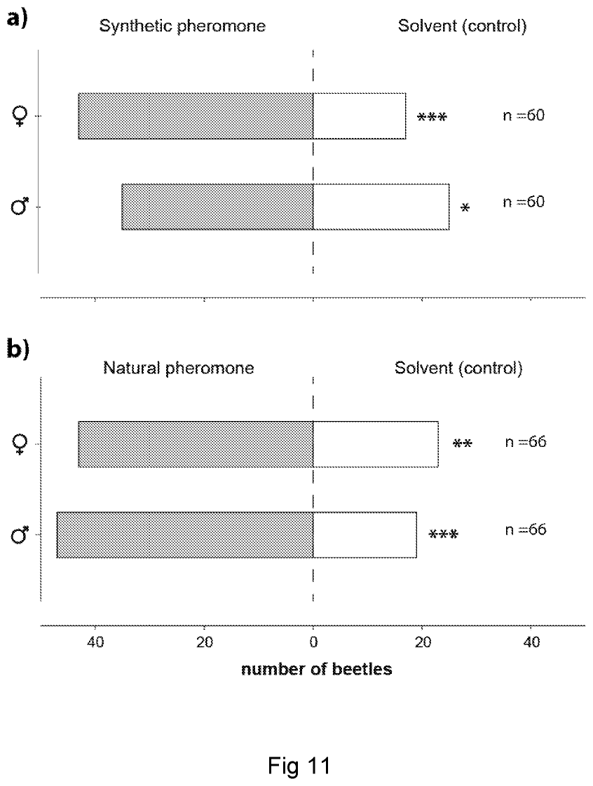

Results suggest that fractions of pheromone 2 (2E,4E,6E,8E)-3,5,7-trimethyl-2,4,6,8-undecatetraene) isolated from both beetles and tri-species mix extracts exerted a comparable level of attraction (FIG. 11), which further corroborate that they are the same entity.

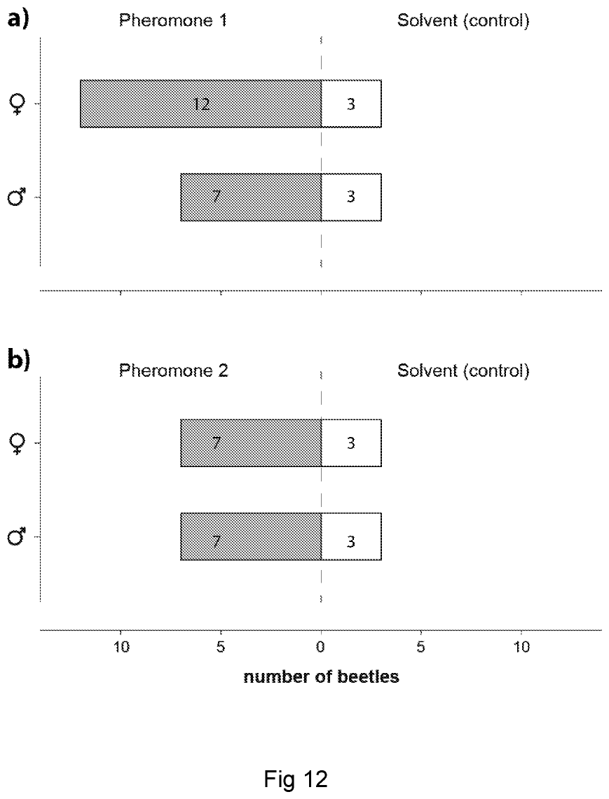

Pheromone 1 (found in a lower amount in beetle odour) appeared to be more attractive than pheromone 2 (FIG. 12)

Follow up experiments will assess beetle attraction to the two pheromones applied in a similar 1:15 (phero 1 : phero 2) ratio to that encountered in beetle odour extracts.

### Example 7—Field Trials Assessing the Influence of the Commercial Tri-Species Pheromone Mix Combined with the Commercial Co-Attractant on C. truncatus Catches

TABLE 3
Composition of lures used to test the influence of commercial
pheromone septa combined with the commercial co-attractant
(CL) on C. truncatus catches in the field

| Lure | Composition | Vol* | | Ethanol | Pheromones |
|---|---|---|---|---|---|
| CL | Acetaldehyde | 163.5 | μl | 45% | No pheromone |
| CL + | Ethyl acetate | 261 | μL | | Tri-species |
| phero | 2-methyl-propanol | 84.5 | μl | | pheromone septum |
| | Isopentyl alcohol | 185.8 | μl | | |
| | 2-methyl-butanol | 61 | μl | | |

*Volumes used to prepare 250 ml of co-attractant solution

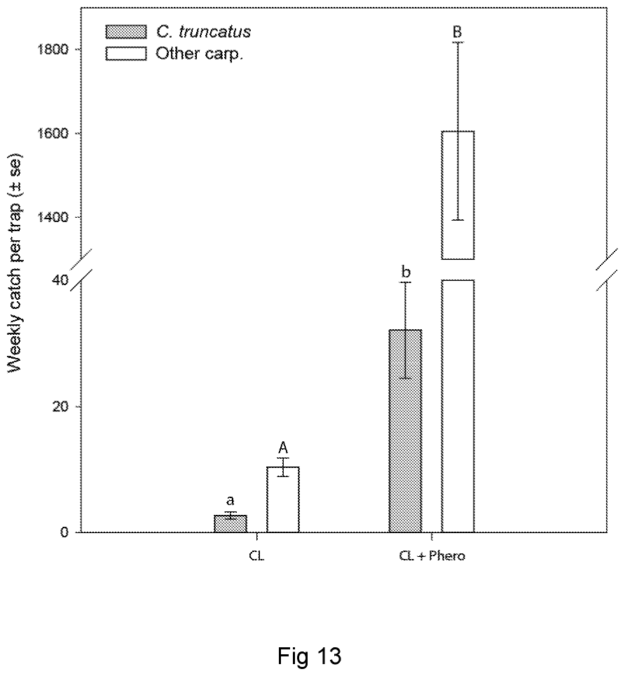

Results confirmed that the use of the commercial pheromone mix (which contains the two identified C. truncatus pheromone compounds with its blend) increases beetle captures by up to 15 times (FIG. 13).

### Example 8—Improvements to the Synthetic Food Attractant (Co-Attractant)

In addition to investigating the C. truncatus pheromone, a new co-attractant (food attractant) was developed using laboratory cage bioassays (Table 4) and tested in the field.

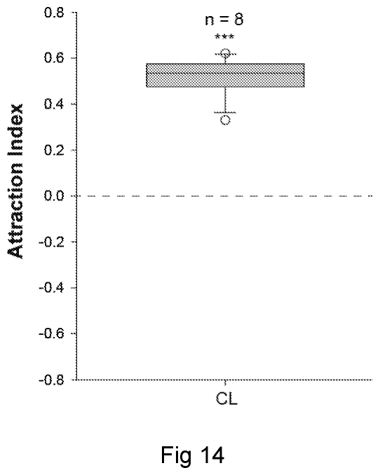

In a first cage experiment (Experiment #1, table 4), the attraction of C. truncatus attraction to the commercial co-attractant (CL) was verified using water as a control treatment (FIG. 14).

In a second experiment (Experiment #2, table 4), the influence of individual components of the commercial co-attractant on C. truncatus was assessed by testing beetle's preferences between test co-attractant solutions in which a single compound was missing against the full formulation.

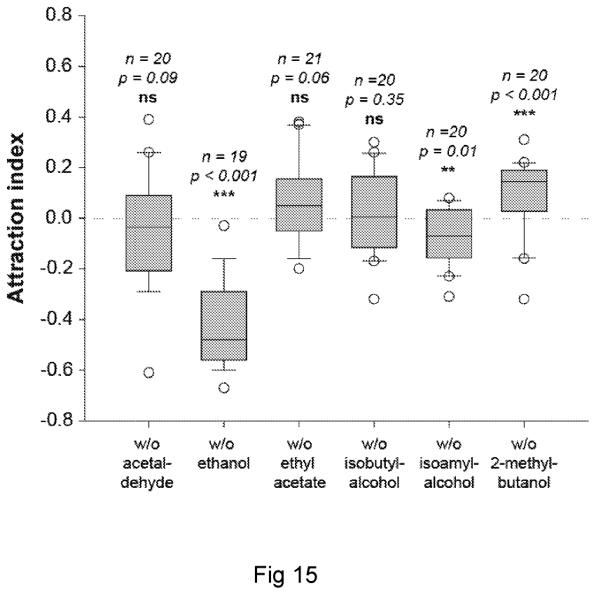

The results indicated that acetaldehyde, ethyl acetate and 2-methylbutanol exhibited a deterrent effect on C. truncatus. Conversely, ethanol and isopentyl alcohol were identified as the main attractants, whilst isobutyl alcohol had no observable effect (FIG. 15).

Lab bioassays showed that only two compounds of the six-compound commercial co-attractant (originally developed to target stone fruit Carpophilus) were attractive to C. truncatus. Of the remaining four compounds, two did not influence C. truncatus behaviour and two were identified as repellents.

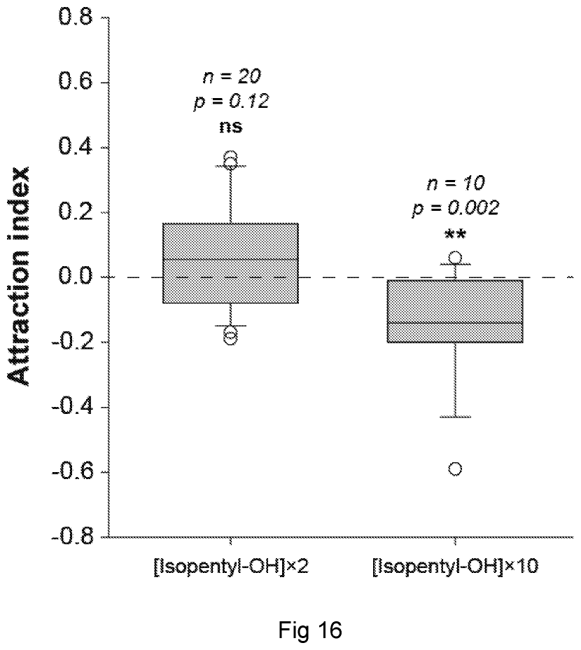

In a third experiment (Experiment #3, table 4), a marginal increase on C. truncatus attraction was observed when the concentration of isoamyl alcohol in the simplified co-attractant (2-components) was doubled compared to the concentration used in the commercial co-attractant. However, a ten-times increase of isopentyl had an adverse effect on C. truncatus attraction (FIG. 16).

TABLE 4
Compositions of the test and control solutions used in cage bioassays

| | Test solutions | | | Control | | |
|---|---|---|---|---|---|---|
| | Composition | Vol* | | Composition | Vol* | |
| Experiment #1 | | | | | | |
| CL vs water | Acetaldehyde | 163.5 | μl | Water | | |
| | Ethyl acetate | 261 | μL | | | |
| | Isobutyl | 84.5 | μl | | | |
| | alcohol | 185.8 | μl | | | |
| | Isopentyl | 61 | μl | | | |
| | alcohol | 45% | | | | |
| | 2-methyl- | | | | | |
| | butanol | | | | | |
| | In ethanol | | | | | |
| Experiment #2 | | | | | | |
| w/o acetaldehyde | [symbol] | [symbol] | | Acetaldehyde | 163.5 | μl |
| vs CL | Ethyl acetate | 261 | μL | Ethyl acetate | 261 | μL |
| | Isobutyl | 84.5 | μl | Isobutyl alcohol | 84.5 | μl |
| | alcohol | 185.8 | μl | Isopentyl alcohol | 185.8 | μl |
| | Isopentyl | 61 | μl | 2-methyl-butanol | 61 | μl |
| | alcohol | 45% | | In ethanol | 45% | |
| | 2-methyl- | | | | | |
| | butanol | | | | | |
| | In ethanol | | | | | |
| w/o ethanol | Acetaldehyde | 163.5 | μl | | | |
| vs CL | Ethyl acetate | 261 | μL | | | |
| | Isobutyl | 84.5 | μl | | | |
| | alcohol | 185.8 | μl | | | |
| | Isopentyl | 61 | μl | | | |
| | alcohol | | | | | |
| | 2-methyl- | | | | | |
| | butanol | | | | | |
| | In water | | | | | |
| w/o Isobutyl alcohol | Acetaldehyde | 163.5 | μl | | | |
| vs CL | Ethyl acetate | 261 | μL | | | |
| | [symbol] | [symbol] | | | | |
| | [symbol] | 185.8 | μl | | | |
| | Isopentyl | 61 | μl | | | |
| | alcohol | 45% | | | | |
| | 2-methyl- | | | | | |
| | butanol | | | | | |
| | In ethanol | | | | | |
| w/o Isopentyl alcohol | Acetaldehyde | 163.5 | μl | | | |
| vs CL | Ethyl acetate | 261 | μL | | | |
| | Isobutyl | 84.5 | μl | | | |
| | alcohol | [symbol] | | | | |
| | [symbol] | 61 | μl | | | |
| | [symbol] | 45% | | | | |
| | 2-methyl- | | | | | |
| | butanol | | | | | |
| | In ethanol | | | | | |
| w/o 2-methyl-butanol | Acetaldehyde | 163.5 | μl | | | |
| vs CL | Ethyl acetate | 261 | μL | | | |
| | Isobutyl | 84.5 | μl | | | |
| | alcohol | 185.8 | μl | | | |
| | Isopentyl | [symbol] | | | | |
| | alcohol | 45% | | | | |
| | [symbol] | | | | | |
| | [symbol] | | | | | |
| | In ethanol | | | | | |
| Experiment #3 | | | | | | |
| [Isopentyl-OH]*2 vs | Isopentyl | 371.6 | μl | Isopentyl alcohol | 185.8 | μl |
| [Isopentyl OH]*1 | alcohol | 45% | | In ethanol | 45% | |
| | In ethanol | | | | | |
| [Isopentyl-OH]*10 vs | Isopentyl | 1.86 | ml | | | |

| | | |
|---|---|---|
| [Isopentyl-OH]*1 | alcohol | 45% |
| | In ethanol | |

*Volumes used to prepare 250 ml of co-attractant solution

The ratio of these two compounds, which were found attractive to C. truncatus, was further optimised using more test lures in field experiments (Table 5).

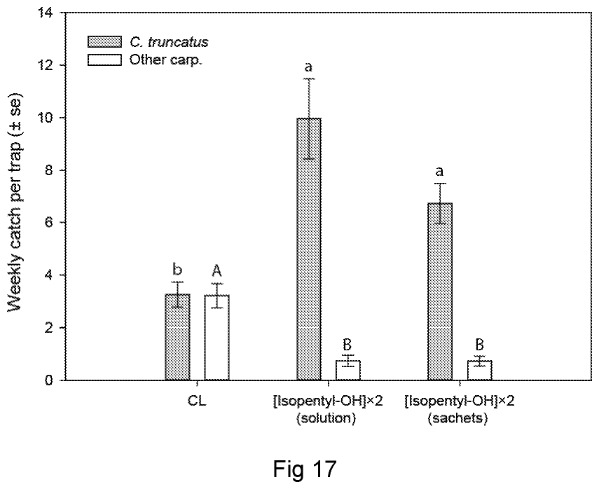

In a first field experiment, greater C. truncatus captures were obtained using the simplified co-attractant developed using cage bioassays both in its solution and sachet (FIG. 4) formulations than with the commercial co-attractant (FIG. 17).

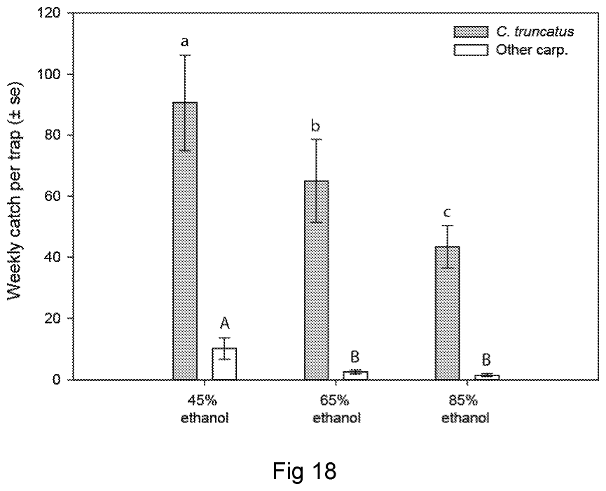

In a second field experiment, 45% ethanol was confirmed as the optimal concentration in the simplified co-attractant as opposed to 65% and 85% that yielded lower C. truncatus catches (FIG. 18).

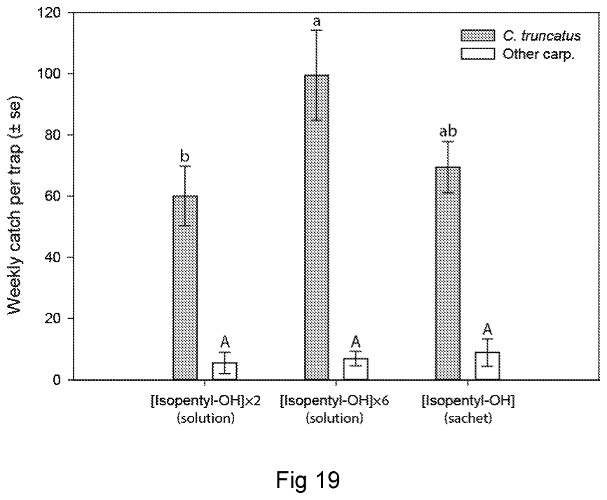

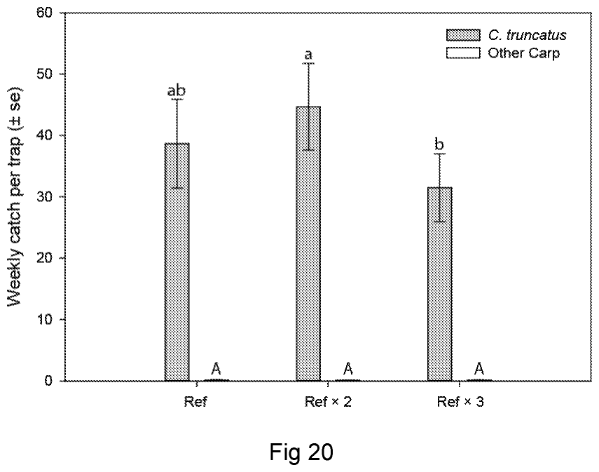

In subsequent field trials, higher concentrations of isopentyl alcohol were shown to significantly increase C. truncatus attraction (FIG. 19). An optimal concentration of isopentyl alcohol beyond which beetle attraction declined the co-attractant was identified (FIG. 20, Table 6).

TABLE 5
Summary of the treatments used in different field trials

| | Composition | Vol* | | Ethanol | sachets |
|---|---|---|---|---|---|
| Field trial #1 | | | | | |
| CL | Acetaldehyde | 163.5 | μl | 45% | — |
| | Ethyl acetate | 261 | μL | | |
| | 2-methylpropan-1-ol | 84.5 | μl | | |
| | Isopentyl alcohol | 185.8 | μl | | |
| | 2-methyl-butanol | 61 | μl | | |
| [Isopentyl-OH]*2 | Isopentyl alcohol | 375 | μl | | — |
| (sol) | | | | | |
| Isopentyl-OH | | — | | | 50 μm, 2.5 × |
| (sachet) | | | | | 2.5 cm, 1 ml load |
| Field trial #2 | | | | | |
| 45% EtOH | Isopentyl alcohol | 375 | μl | 45% | — |
| 65% EtOH | | | | 65% | |
| 85% EtOH | | | | 85% | |
| Field trial #3a | | | | | |
| [Isopentyl-OH]*2 | Isopentyl alcohol | 375 | μl | 45% | — |
| [Isopentyl-OH]*6 | | 1.12 | ml | | |
| Isopentyl-OH | | — | | | 50 μm, 5 × |
| (sachet) | | | | | 5 cm, 2 ml load |
| Field trial #3b | | | | | |
| Ref | Isopentyl alcohol | 1 | ml | 45% | — |
| Ref*2 | | 2 | ml | | |
| Ref*3 | | 3.5 | ml | | |

*Volumes used to prepare 250 ml of co-attractant solution

TABLE 6
Composition of the optimized version of
the simplified co-attractant (Ref).

| Ingredients | Volume | |
|---|---|---|
| Isopentyl alcohol (98%) | 2 | ml |
| Ethanol (96%) | 111.6 | ml |

| | |
|---|---|
| Water | 136.4 |

### Example 9—Testing of the Improved Simplified Co-Attractant with Synthetic Pheromones

TABLE 7
Test treatments involving the simplified and original attractants
tested in the presence of commercial synthetic pheromones.

| Treatment | Composition | Vol* | | Ethanol | Pheromones |
|---|---|---|---|---|---|
| Ref + phero | Isopentyl alcohol | 1 | ml | 45% | 1 tri- |
| CL + phero | Acetaldehyde | 163.5 | μl | | species |
| | Ethyl acetate | 261 | μL | | septum |
| | 2-methylpropan-1-ol | 84.5 | μl | | |
| | Isopentyl alcohol | 185.8 | μl | | |
| | 2-methyl-butanol | 61 | μl | | |

*Volumes used to prepare 250 ml of co-attractant solution

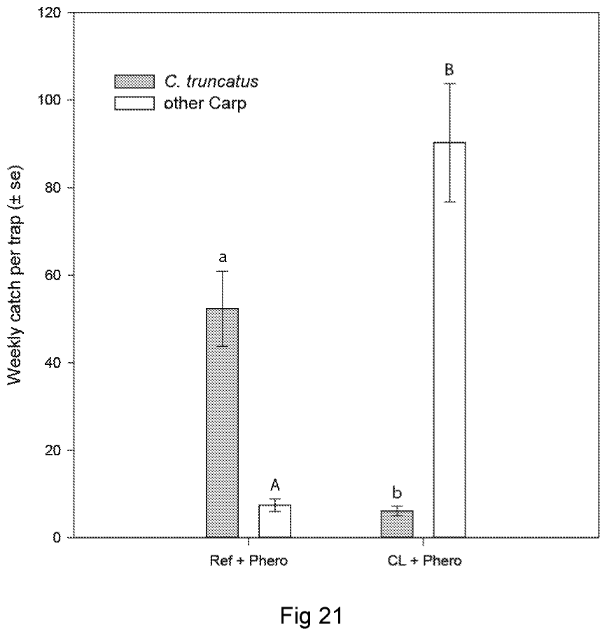

The efficacy of new co-attractant combined with the tri-species pheromone mix was compared with that of the commercial co-attractant (CL) in the field (FIG. 21).

The new co-attractant caught up to ten times more beetles than the original co-attractant while catching about ten times less non-target beetle species.

Finally, it is to be understood that various alterations, modifications and/or additions may be made without departing from the spirit of the present invention as outlined herein.

### REFERENCES

Bartelt R J (2010) Volatile hydrocarbon pheromones from beetles. In: Blomquist G J, Bagnières A-G (eds) Insect Hydrocarbons: Biology, Biochemistry, and Chemical Ecology. Cambridge University Press, pp 448-476
Bartelt R J, Dowd P F, Plattner R D, Weisleder D (1990) Aggregation pheromone of driedfruit beetle, Carpophilus hemipterus Wind-tunnel bioassay and identification of two novel tetraene hydrocarbons. J Chem Ecol 16:1015-1039. doi: 10.1007/BF01021008
Bartelt R J, Weisleder D, Dowd P F, Plattner R D (1992) Male-specific tetraene and triene hydrocarbons of Carpophilus hemipterus: Structure and pheromonal activity. J Chem Ecol 18:379-402. doi: 10.1007/BF00994239
Baig F et al. (2020) Chemical ecology of Carpophilus beetles and their yeast symbionts. PhD thesis. Queensland University of Technology. (Published 25 Aug. 2020).

1. A composition for attracting Carpophilus beetles, wherein the composition includes one or more pheromone compounds produced from male Carpophilus beetles of the species Carpophilus truncatus.

2. A composition according to claim 1, wherein the pheromone compounds are methyl and/or ethyl branched polyenes.

3. A composition according to claim 1 or 2, wherein the pheromone compounds are selected from (2E,4E,6E,8E)-7-Ethyl-3,5-dimethyl-2,4,6,8-decatetraene and (2E,4E,6E,8E)-3,5,7-trimethyl-2,4,6,8-undecatetraene.

4. A composition according to any one of claims 1 to 3, wherein the composition includes both (2E,4E,6E,8E)-7-Ethyl-3,5-dimethyl-2,4,6,8-decatetraene and (2E,4E,6E,8E)-3,5,7-trimethyl-2,4,6,8-undecatetraene.

5. A composition according to claim 3 or 4, wherein the composition substantially excludes pheromones other than (2E,4E,6E,8E)-7-Ethyl-3,5-dimethyl-2,4,6,8-decatetraene and (2E,4E,6E,8E)-3,5,7-trimethyl-2,4,6,8-undecatetraene

6. A composition according to claim 4 or 5, wherein (2E,4E,6E,8E)-7-Ethyl-3,5-dimethyl-2,4,6,8-decatetraene and (2E,4E,6E,8E)-3,5,7-trimethyl-2,4,6,8-undecatetraene are present at a ratio of between approximately 1:1 and 1:100 (v/v).

7. A composition according to claim 5 or 6, wherein (2E,4E,6E,8E)-7-Ethyl-3,5-dimethyl-2,4,6,8-decatetraene and (2E,4E,6E,8E)-3,5,7-trimethyl-2,4,6,8-undecatetraene are present at a ratio of between approximately 1:5 and 1:50.

8. A composition according to any one of claims 5 to 7, wherein (2E,4E,6E,8E)-7-Ethyl-3,5-dimethyl-2,4,6,8-decatetraene and (2E,4E,6E,8E)-3,5,7-trimethyl-2,4,6,8-undecatetraene are present at a ratio of approximately 1:15.

9. A composition according to any one of claims 1 to 8, wherein the composition includes a co-attractant mixture.

10. A composition according to claim 9, wherein the co-attractant mixture includes one or more compounds selected from ethanol, acetaldehyde, ethyl acetate, isobutanol, isopentyl alcohol, and 2-methylbutanol.

11. A composition according to claim 9 or 10, wherein the co-attractant mixture includes at least one alcohol.

12. A composition according to claim 11, wherein the alcohol is ethanol and/or isopentyl alcohol.

13. A composition according to any one of claims 9 to 12, wherein the co-attractant mixture includes both isopentyl alcohol and ethanol at a ratio approximately between 1:10 and 1:150 (v/v).

14. A composition according claim 13, wherein the isopentyl alcohol and ethanol are at a ratio approximately between 1:25 and 1:100 (v/v).

15. A composition according to claim 14, wherein isopentyl alcohol and ethanol is present at a ratio of approximately 1:56 (v/v).

16. A composition according to any one of claims 1 to 15, wherein the attracted Carpophilus beetles are of the species Carpophilus truncatus, Carpophilus hemipterus, Carpophilus davidsoni, Carpophilus humeralis.

17. A composition according to any one of claims 1 to 16, wherein the composition is a liquid and/or gas mixture.

18. A composition for attracting Carpophilus beetles, wherein the composition includes (2E,4E,6E,8E)-7-Ethyl-3,5-dimethyl-2,4,6,8-decatetraene, (2E,4E,6E,8E)-3,5,7-trimethyl-2,4,6,8-undecatetraene, and one or more co-attractants selected from the group consisting of ethanol, acetaldehyde, ethyl acetate, isobutanol, isopentyl alcohol, and 2-methylbutanol.

19. A composition according to claim 18, wherein the composition includes (2E,4E,6E,8E)-7-Ethyl-3,5-dimethyl-2,4,6,8-decatetraene, (2E,4E,6E,8E)-3,5,7-trimethyl-2,4,6,8-undecatetraene, ethanol and isopropanol.

20. An apparatus for dispensing a composition according to any one of claims 1 to 19.

21. An apparatus according to claim 20, wherein the apparatus provides for regulated release of the composition.

22. An apparatus according to claim 21, wherein the apparatus provides for regulated release of the composition for between approximately 1 to 8 weeks.

23. An apparatus according to any one of claims 20 to 22, wherein the apparatus includes:
at least one deposit element for storage of the composition, and
at least one casing for housing the deposit element,
wherein the deposit element releases the composition and the casing provides a means for release of the composition into the surrounding environment.

24. An apparatus according to claim 23, wherein the casing is made of low density polyethylene having a thickness between approximately 20 μm to 300 μm.

25. An apparatus according to any one of claims 20 to 22, wherein the apparatus is a rubber septum.

26. A device for trapping Carpophilus beetles including the composition according to any one of claims 1 to 24.

27. A device for trapping Carpophilus beetles including one or more of the apparatus according to any one of claims 20 to 25.

28. A method of attracting and/or trapping Carpophilus beetles including the step of exposing a beetle infested environment to a composition, apparatus, and/or device according to any one of claims 1 to 27.

29. A method of monitoring for the presence of Carpophilus beetles including positioning a device according to claim 26 or 27, within an environment that requires monitoring for the presence of beetles.
